(19) United States
(12) Patent Application Publication
(10) Pub. No.: US 2022/0366865 A1
(43) Pub. Date: Nov. 17, 2022

(54) METHOD OF WHITE BALANCE ADJUSTMENT AND LIQUID CRYSTAL DISPLAY

(71) Applicant: TCL CHINA STAR OPTOELECTRONICS TECHNOLOGY CO., LTD., Shenzhen, Guangdong (CN)

(72) Inventor: Guangxing XIAO, Shenzhen, Guangdong (CN)

(21) Appl. No.: 17/262,724

(22) PCT Filed: Dec. 18, 2020
(86) PCT No.: PCT/CN2020/137564

§ 371 Date: Jan. 24, 2021

(30) Foreign Application Priority Data
Dec. 2, 2020 (CN) 202011398981.1

(51) Int. Cl. G09G 3/36

(52) U.S. Cl. CPC G09G 3/3607; G09G 2320/0666; G09G 2320/0242; G09G 2320/046

(57) ABSTRACT

A method of white balance adjustment and a liquid crystal display are disclosed. The method includes obtaining a total run-time of a liquid crystal display (LCD) panel; finding a corresponding white balance parameter according to the total run-time; and compensating the LCD panel with the corresponding white balance parameter, so as to adjust the corresponding white balance parameter according to a run-time of the LCD panel. The corresponding white balance parameter can be selected according to aging time of liquid crystals.

The present application claims priority of a Chinese patent application filed on Dec. 2, 2020 with the National Intellectual Property Administration, application number 202011398981.1, titled “Method of white balance adjustment, device thereof, and liquid crystal display”, which is incorporated by reference in the present application in its entirety.

### FIELD OF INVENTION

The present application relates to the field of liquid crystal display technologies, and in particular to a method of white balance adjustment and a liquid crystal display.

### BACKGROUND OF INVENTION

Liquid crystal displays (LCDs) are flat and ultra-thin display devices. They consist of a certain number of color or black and white pixels and are placed in front of a light source or reflector. The liquid crystal displays have very low power consumption, and have characteristics of high image quality, small size, and light weight. LCD panels are a main component of the liquid crystal displays, which generally include a color filter substrate and a thin film transistor (TFT) array substrate arranged oppositely, and a liquid crystal layer sandwiched between the two substrates. With development of flat panel display technologies, people have higher and higher requirements for image quality, including brightness, color, resolution, viewing angles, refresh speed, etc.

### Technical Problem

Due to differences in assembly of entire machines, color differences will exist in different LCD panels; or due to delay of data signals, the LCD panels will have color shift problems when displaying images. Therefore, a white balance correction will be performed through an optical white tracking (WT) adjustment. During the white balance correction, relevant white balance parameters are adjusted to compensate, so that the LCD panels of different entire machines reach within an error range of same color coordinate, and reduce a color shift phenomenon.

However, with operation of the LCD panels, liquid crystals in the liquid crystal layer of the LCD panels will correspondingly age, causing optical characteristics of the liquid crystals to change. However, pre-adjusted white balance parameters are always same group of parameters and will not be updated. If a compensation is still performed according to original white balance parameters, a result of the white balance correction will be affected and a liquid crystal displaying quality cannot be improved.

### SUMMARY OF INVENTION

### Technical Solutions

The purpose of the present application is to provide a method of white balance adjustment and a liquid crystal display (LCD), which can adjust white balance parameters with a run-time of a LCD panel, improving result of a white balance correction, and enhancing a liquid crystal display quality.

In order to achieve the above objective, a method of white balance adjustment is provided in an embodiment of the present application. The method includes following steps: after each booting of the LCD panel, reading a first run-time of an LCD panel after a previous booting of the LCD panel; counting a run-time of the LCD panel after a present booting of the LCD panel to obtain a second run-time; obtaining a sum of the second run-time and the first run-time as a total run-time of the LCD panel; looking up a pre-configured total run-time to white balance parameter table according to the total run-time, and finding out a corresponding white balance parameter, wherein the total run-time to white balance parameter table includes multiple groups of run-time ranges and white balance parameter correspondence relationships; and compensating the LCD panel with the corresponding white balance parameter, so as to adjust the corresponding white balance parameter according to the run-time of the LCD panel.

In order to achieve the above objective, the white balance adjustment method is provided in yet another embodiment of the present application. The method includes following steps: obtaining a total run-time of a liquid crystal display (LCD) panel; finding out a corresponding white balance parameter according to the total run-time; and compensating the LCD panel with the corresponding white balance parameter, so as to adjust the corresponding white balance parameter according to the run-time of the LCD panel.

In order to achieve the above objective, in yet another embodiment of the present application, a liquid crystal display for realizing white balance adjustment is provided, including a white balance adjustment device. Wherein. the white balance adjustment device includes: an obtaining unit configured to obtain a total run-time of an LCD panel; a matching unit configured to find out a corresponding white balance parameter according to the total run-time; and a compensation unit configured to compensate the LCD panel with the corresponding white balance parameter, so as to adjust the corresponding white balance parameter according to the run-time of the LCD panel.

### Beneficial Effect

The present application records the run-time of the LCD panel and selects different white balance parameters for compensation according to the run-time of the LCD panel, thus realizing that the corresponding white balance parameter can be selected according to aging time of liquid crystals. The result of the white balance correction is improved, the liquid crystal displaying quality is enhanced, and the competitiveness of products can be enhanced.

### BRIEF DESCRIPTION OF FIGURES

FIG. 1 is a flowchart of a method of white balance adjustment according to a first embodiment of the present application.

FIG. 2A is a flowchart of the method of white balance adjustment according to a second embodiment of the present application.

FIG. 2B is a flowchart of obtaining a run-time of a liquid crystal display panel according to an embodiment of the present application.

FIG. 3 is a schematic block diagram of a white balance adjustment device according to a third embodiment of the present application.

FIG. 4 is a schematic structural diagram of a liquid crystal display according to a fourth embodiment of the present application.

### DETAILED DESCRIPTION OF EMBODIMENTS

In order to make the purpose, technical solutions, and effects of the present application in a clearer manner, the following further describes the present application in detail with reference to the drawings and embodiments. It should be understood that the specific embodiments described here are only used to explain the present application, and not used to limit the application.

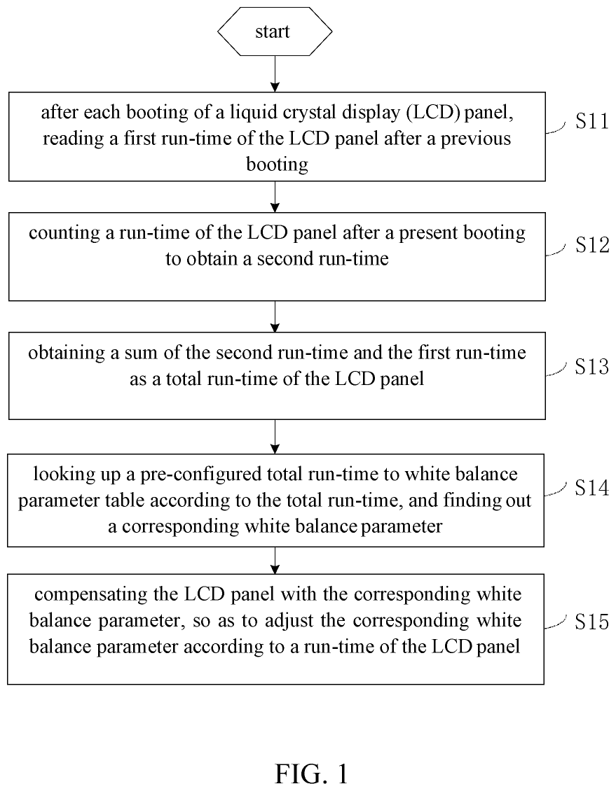

Refer to FIG. 1, which is a flowchart of a method of white balance adjustment according to a first embodiment of the present application.

As shown in FIG. 1, the method of white balance adjustment of the present embodiment includes following steps: S11, after each booting of a liquid crystal display (LCD) panel, reading a first run-time of the LCD panel after a previous booting; S12, counting a run-time of the LCD panel after a present booting to obtain a second run-time; S13, obtaining a sum of the second run-time and the first run-time as a total run-time of the LCD panel; S14, looking up a pre-configured total run-time to white balance parameter table according to the total run-time, and finding out a corresponding white balance parameter; and S15, compensating the LCD panel with the corresponding white balance parameter, so as to adjust the corresponding white balance parameter according to a run-time of the LCD panel. Detailed descriptions are given below.

Specifically, a first memory can be configured to store the total run-time of the LCD panel. Therefore, the total run-time of the LCD panel can be read by reading data stored in the first memory. After information is written in the first memory, even if a power is turned off, the information will not be lost. The first memory can be a programmable read-only memory, an erasable programmable read-only memory, an electrically erasable programmable read-only memory, and a flash memory, etc.

In a further embodiment, the method further includes counting the run-time of the LCD panel and writing a counting result into the first memory when the LCD panel is booted. Therefore, when the power is turned on next time, the stored run-time can be directly read from the first memory as the run-time of the LCD panel. The run-time of the LCD panel can be timed by a timer.

When the LCD panel is actually used, there are multiple booting/off situations. Therefore, it is necessary to record the run-time of each booting, and superimpose the previous run-time to form the total run-time, so as to more accurately reflect aging of liquid crystals in the LCD panel. Therefore, in a further embodiment, the method further includes after each booting of the LCD panel, reading the first run-time of the LCD panel after the previous booting from the first memory after each booting of the LCD panel; counting the run-time of the LCD panel after the present booting to obtain the second run-time; and obtaining the sum of the second run-time and the first run-time and writing the sum into the first memory to update the total run-time. The run-time of the LCD panel can be timed by the timer, a corresponding run-time can be read from the first memory by a timing controller, and the total run-time can be obtained and written into the first memory.

Specifically, a table lookup method can be configured to quickly match the corresponding white balance parameter according to the total run-time. After each booting of the LCD panel, a total run-time to white balance parameter table can be looked up according to the total run-time to match the corresponding white balance parameter. Wherein, the total run-time to white balance parameter table can include multiple run-time ranges, and each of the run-time ranges corresponds to a white balance parameter. According to an obtained run-time range of the total run-time, the corresponding white balance parameter is matched. That is, as the run-time of the LCD panel increases, an aging degree of a device increases, and a degree of color shift will change accordingly. In order to obtain a standard display effect, different white balance parameters are selected for compensation instead of a compensation method using correspondingly a fix set of white balance parameters. Thereby, a result of a white balance correction can be improved and a liquid crystal displaying quality can be enhanced.

Specifically, a second memory can be configured to store the total run-time to white balance parameter table. After the information is written in the second memory, even if the power is turned off, the information will not be lost. The second memory can be a programmable read-only memory, an erasable programmable read-only memory, an electrically erasable programmable read-only memory, a flash memory, and the like. The white balance parameter used in the present booting is based on the total run-time read from the first memory (that is, the time that the LCD panel has been running before the present booting), and the corresponding white balance parameter is matched from the total run-time to white balance parameter table. After the present booting, a current run-time can be counted, and the run-time previously read from the first memory can be superimposed to form the total run-time to update the total run-time in the first memory. Therefore, the white balance parameter adopted after the next booting is the corresponding white balance parameter matched according to the updated total run-time read from the first memory. Therefore, the white balance parameter can be adjusted with the run-time of the LCD panel (the run-time reflects the aging of the liquid crystals in the LCD panel).

Because the white balance parameter is related to the run-time of the LCD panel, that is, according to the run-time of the LCD panel, different white balance parameters are selected for compensation instead of a compensation method using correspondingly a fix set of white balance parameters. Therefore, the white balance correction result is improved and the liquid crystal displaying quality is enhanced.

In the present embodiment, by recording the run-time of the LCD panel, and selecting different white balance parameters for compensation according to the run-time of the LCD panel, the result of the white balance correction is improved, the liquid crystal displaying quality is enhanced, and the competitiveness of products can be enhanced.

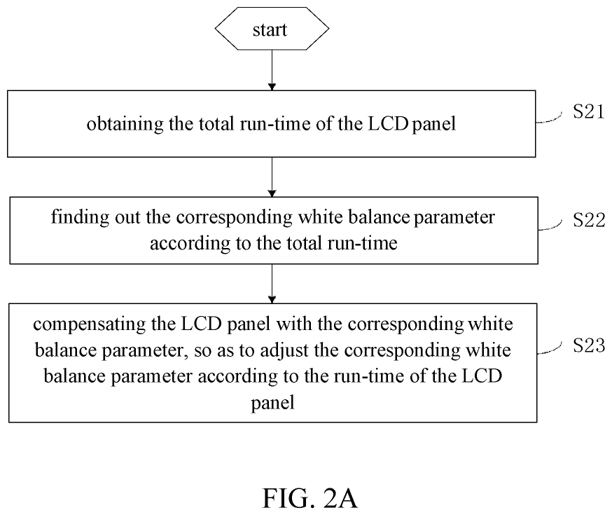

Refer to FIGS. 2A-2B together, in which FIG. 2A is a flowchart of the method of white balance adjustment according to a second embodiment of the present application, and FIG. 2B is a flowchart of obtaining the run-time of the LCD panel according to an embodiment of the present application.

As shown in FIG. 2A, the method of white balance adjustment of the present embodiment includes following steps: S21, obtaining the total run-time of the LCD panel; S22, finding out the corresponding white balance parameter according to the total run-time; and S23, compensating the LCD panel with the corresponding white balance parameter, so as to adjust the corresponding white balance parameter according to the run-time of the LCD panel. Detailed descriptions are given below.

Regarding the step S21, obtaining the total run-time of the LCD panel. Specifically, after each booting of the LCD panel, reading the first run-time of the LCD panel after the previous booting, counting the run-time of the LCD panel after the present booting to obtain the second run-time, and obtaining the sum of the second run-time and the first run-time as the total run-time of the LCD panel. The first memory can be configured to store the total run-time of the LCD panel. Therefore, the total run-time of the LCD panel can be read by reading the data stored in the first memory. After the information is written in the first memory, even if the power is turned off, the information will not be lost. The first memory can be a programmable read-only memory, an erasable programmable read-only memory, an electrically erasable programmable read-only memory, a flash memory, and the like.

Programmable read-only memory (PROM) is a storage memory chip that allows the use of hardware called PROM programmers to write data into the device. Users can write data according to their needs, that is, programing to PROM.

Erasable programmable read-only memory (EPROM) is a ROM memory that has an erasable function and can be reprogrammed after erasing. Users can write data according to their own needs, which they must first irradiate a transparent window on its IC card with ultraviolet rays to clear original stored content before writing.

Electrically erasable programmable read-only memory (EEPROM) is a semiconductor storage device that can be electronically rewritten multiple times. Compared with EPROM, EEPROM does not need to be irradiated with ultraviolet light, and only needs to use a specific voltage to erase the information on the chip in order to write new data.

Flash memory is a kind of electronically erasable and programmable memory that allows it to be erased or written multiple times during operation. Flash memory is a special EPROM that is erased with macro blocks.

In a further embodiment, the method further includes counting the run-time of the LCD panel and writing the counting result into the first memory when the LCD panel is booted. Therefore, when the power is turned on next time, the stored run-time can be directly read from the first memory as the run-time of the LCD panel. The run-time of the LCD panel can be timed by the timer.

When the LCD panel is actually used, there are multiple booting/off situations. Therefore, it is necessary to record the run-time of each booting, and superimpose the previous run-time to form the total run-time, so as to more accurately reflect aging of liquid crystals in the LCD panel. Therefore, in a further embodiment, the method further includes: S211, after each booting of the LCD panel, reading the first run-time of the LCD panel after the previous booting from the first memory; S212, counting the run-time of the LCD panel after the present booting to obtain the second run-time; and S213, obtaining the sum of the second run-time and the first run-time, and writing the sum into the first memory to update the total run-time, as shown in FIG. 2. The run-time of the LCD panel can be timed by the timer, a corresponding run-time can be read from the first memory by a timing controller, and the total run-time can be obtained and written into the first memory.

Regarding the step S22, finding out the corresponding white balance parameter according to the total run-time. It can be looking up the pre-configured total run-time to white balance parameter table that includes multiple groups of run-time ranges and white balance parameter correspondence relationships according to the total run-time, and finding out the corresponding white balance parameter. That is, the table lookup method can be configured to quickly match the corresponding white balance parameter according to the total run-time.

Specifically, a total run-time to white balance parameter table including multiple groups of run-time ranges and white balance parameter correspondence relationships can be pre-configured. Therefore, the pre-configured total run-time to white balance parameter table can be looked up according to the total run-time, and the corresponding white balance parameter is matched. After each booting of the LCD panel, the total run-time to white balance parameter table can be looked up according to the total run-time to match the corresponding white balance parameter. Wherein, the total run-time to white balance parameter table can include multiple run-time ranges, and each run-time range corresponds to a white balance parameter. According to the obtained run-time range of the total run-time, the corresponding white balance parameter is matched. That is, as the run-time of the LCD panel increases, the aging degree of a device increases, and a degree of color shift will change accordingly. In order to obtain a standard display effect, different white balance parameters are selected for compensation instead of a compensation method using correspondingly a fix set of white balance parameters. Thereby, a result of a white balance correction can be improved and a liquid crystal displaying quality can be enhanced.

Specifically, the second memory can be configured to store the total run-time to white balance parameter table. After the information is written in the second memory, even if the power is turned off, the information will not be lost. The second memory can be a programmable read-only memory, an erasable programmable read-only memory, an electrically erasable programmable read-only memory, a flash memory, and the like. The white balance parameter used in the present booting is based on the total run-time read from the first memory (that is, the time that the LCD panel has been running before the present booting), and the corresponding white balance parameter is matched from the total run-time to white balance parameter table. After the present booting, a current run-time can be counted, and the run-time previously read from the first memory can be superimposed to form the total run-time to update the total run-time in the first memory. Therefore, the white balance parameter adopted after the next booting is the corresponding white balance parameter matched according to the updated total run-time read from the first memory. Therefore, the white balance parameter can be adjusted with the run-time of the LCD panel (the run-time reflects the aging of the liquid crystals in the LCD panel).

Regarding the step S23, compensating the LCD panel with the corresponding white balance parameter, so as to adjust the corresponding white balance parameter according to the run-time of the LCD panel. Because the white balance parameter is related to the run-time of the LCD panel, that is, according to the run-time of the LCD panel, different white balance parameters are selected for compensation instead of a compensation method using correspondingly a fix set of white balance parameters. Therefore, the white balance correction result is improved and the liquid crystal displaying quality is enhanced.

In the present embodiment, by recording the run-time of the LCD panel, and selecting different white balance parameters for compensation according to the run-time of the LCD panel, the result of the white balance correction is improved, the liquid crystal displaying quality is enhanced, and the competitiveness of products can be enhanced.

Based on a same inventive concept, the present application further provides a white balance adjustment device.

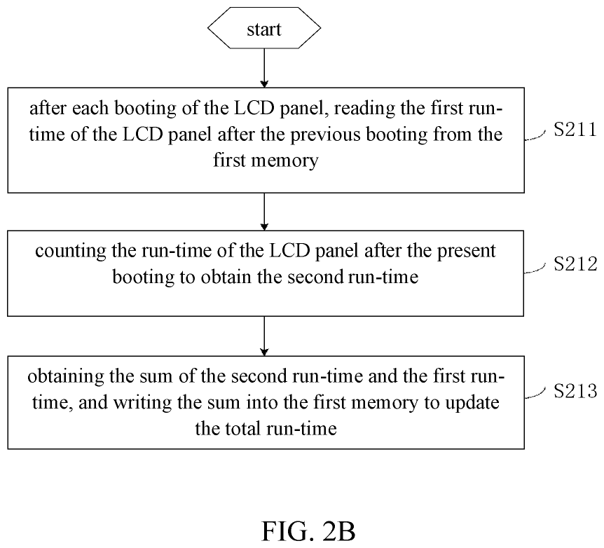

Refer to FIG. 3, which is a schematic block diagram of a white balance adjustment device according to a third embodiment of the present application. The white balance adjustment device 30 described in the present embodiment includes an obtaining unit 32, a matching unit 34, and a compensation unit 36.

The obtaining unit 32 is configured to obtain the total run-time of the LCD panel. Specifically, the first memory 301 can be configured to store the total run-time of the LCD panel. Therefore, the total run-time of the LCD panel can be read by reading the data stored in the first memory.

The matching unit 34 is configured to match and find out the corresponding white balance parameter according to the total run-time. The total run-time to white balance parameter table including multiple groups of run-time ranges and white balance parameter correspondence relationships can be pre-configured. Then, the table lookup method can be configured to quickly match the corresponding white balance parameter according to the total run-time. Specifically, the second memory 302 can be configured to store the total run-time to white balance parameter table.

The compensation unit 36 is configured to compensate the LCD panel with the corresponding white balance parameter, so as to adjust the corresponding white balance parameter according to the run-time of the LCD panel. Because the white balance parameter is related to the run-time of the LCD panel, that is, according to the run-time of the LCD panel, different white balance parameters are selected for compensation instead of a compensation method using correspondingly a fix set of white balance parameters. Therefore, the white balance correction result is improved and the liquid crystal displaying quality is enhanced.

When the LCD panel is actually used, there are multiple booting/off situations. Therefore, it is necessary to record the run-time of each booting, and superimpose the previous run-time to form the total run-time, so as to more accurately reflect aging of liquid crystals in the LCD panel. Therefore, in a further embodiment, the device can further include a first memory 301, a timer 303, and an update unit 304.

The timer 303 is configured to count the run-time of the LCD panel after the LCD panel is booted, and write the counting result into the first memory 301. After the information is written in the first memory 301, the information will not be lost even if the power is turned off. The first memory 301 can be a programmable read-only memory, an erasable programmable read-only memory, an electrically erasable programmable read-only memory, a flash memory, and the like.

The update unit 304 is configured to read the first run-time of the LCD panel after the previous booting from the first memory 301, to obtain a sum of a second run-time of the LCD panel after a present booting of the LCD panel and the first run-time, and to write the sum into the first memory 301 to update the total run-time in the first memory 301. Wherein, the second run-time is obtained by using the timer 303 to count the run-time of the LCD panel after present booting.

The updated total run-time is stored in the first memory 301, so that in the next booting, the stored run-time can be directly read from the first memory 301 as the total run-time of the LCD panel. Specifically, the obtaining unit 32, the matching unit 34, the compensation unit 36, and the update unit 304 can implement corresponding functions through a timing controller.

In a further embodiment, the device further includes a configuration unit 305. The configuration unit 305 is configured to pre-configure a total run-time to white balance parameter table including multiple groups of run-time ranges and white balance parameter correspondence relationships. Therefore, the matching unit 36 can look up the total run-time to white balance parameter table according to the total run-time after booting of the LCD panel, and the corresponding white balance parameter is matched.

Specifically, the configuration unit 305 can be configured to pre-configure the total run-time to white balance parameter table including multiple groups of run-time ranges and white balance parameter correspondence relationships. Wherein, the total run-time to white balance parameter table can include multiple run-time ranges, and each run-time range corresponds to a white balance parameter. The matching unit 36 can find out the corresponding white balance parameter according to the obtained run-time range of the total run-time. That is, as the run-time of the LCD panel increases, the aging degree of a device increases, and a degree of color shift will change accordingly. In order to obtain a standard display effect, different white balance parameters are selected for compensation instead of a compensation method using correspondingly a fix set of white balance parameters. Thereby, a result of a white balance correction can be improved and a liquid crystal displaying quality can be enhanced.

The total run-time to white balance parameter table can be stored in the second memory 302. After the information is written in the second memory 302, the information will not be lost even if the power is turned off. The second memory can be a programmable read-only memory, an erasable programmable read-only memory, an electrically erasable programmable read-only memory, a flash memory, and the like.

The white balance parameter used in the present booting is based on the total run-time read from the first memory 301 (that is, the time that the LCD panel has been running before the present booting), and the corresponding white balance parameter is matched from the total run-time to white balance parameter table. After the present booting, the timer 303 can be configured to count the run-time of the present running, and the run-time previously read from the first memory 301 can be superimposed to form the total run-time to update the total run-time in the first memory 301. Therefore, the white balance parameter adopted after the next booting is the corresponding white balance parameter matched according to the updated total run-time read from the first memory 301. Therefore, the white balance parameter can be adjusted with the run-time of the LCD panel (the run-time reflects the aging of the liquid crystals in the LCD panel).

In the present embodiment, by recording the run-time of the LCD panel, and selecting different white balance parameters for compensation according to the run-time of the LCD panel, the result of the white balance correction is improved, the liquid crystal displaying quality is enhanced, and the competitiveness of products can be enhanced.

It should be noted that some of the block diagrams shown in the drawings are functional entities and do not necessarily correspond to physically or logically independent entities. These functional entities can be implemented in the form of software, or implemented in one or more hardware circuits or integrated circuits, or implemented in different networks and/or processor devices and/or microcontroller devices.

Based on the same inventive concept, the present application further provides a liquid crystal display, which can realize white balance adjustment.

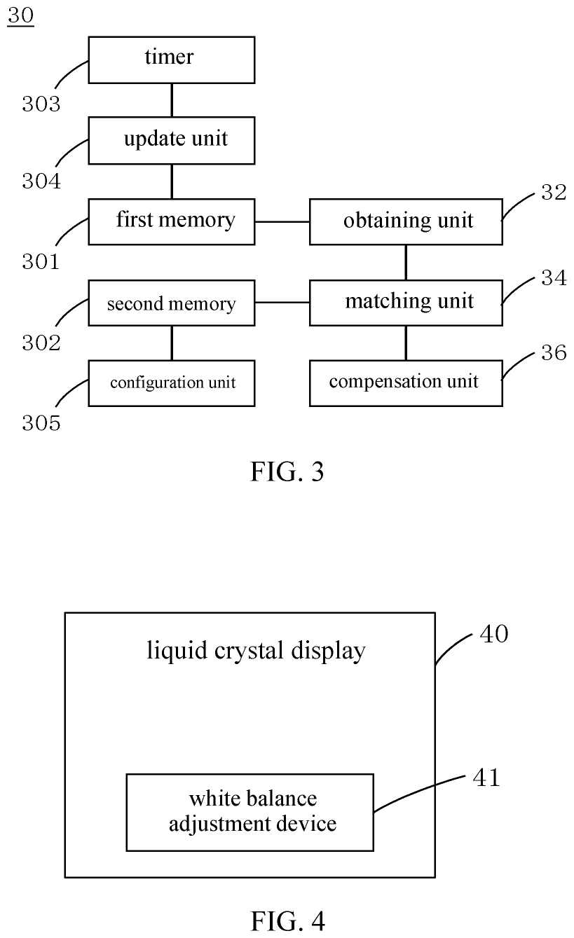

Refer to FIG. 4, which is a schematic structural diagram of the liquid crystal display according to a fourth embodiment of the present application. The liquid crystal display 40 in the present embodiment includes a white balance adjustment device 41. The white balance adjustment device 41 adopts the white balance adjustment device 30 described above in the present application. The specific methods and beneficial effects of the liquid crystal display 40 of the present application for realizing white balance adjustment can be referred to the foregoing, and will not be repeated here.

In the above-mentioned embodiments, the description of each embodiment has its own focus. For parts that are not described in detail in an embodiment, reference can be made to related descriptions of other embodiments.

It can be understood that, for those of ordinary skill in the art, equivalent replacements or changes can be made according to the technical solution of the present application and its inventive concept, and all these changes or replacements shall fall within the protection scope of the appended claims of the present application.

What is claimed is:

1. A method of white balance adjustment, comprising following steps:
after each booting of a liquid crystal display (LCD) panel, reading a first run-time of the LCD panel after a previous booting of the LCD panel;
counting a run-time of the LCD panel after a present booting of the LCD panel to obtain a second run-time;
obtaining a sum of the second run-time and the first run-time as a total run-time of the LCD panel;
looking up a pre-configured total run-time to white balance parameter table according to the total run-time, and finding out a corresponding white balance parameter, wherein the total run-time to white balance parameter table comprises multiple groups of run-time ranges and white balance parameter correspondence relationships; and
compensating the LCD panel with the corresponding white balance parameter, so as to adjust the corresponding white balance parameter according to the run-time of the LCD panel.

2. The method of white balance adjustment according to claim 1, further comprising providing a first memory to store the total run-time.

3. The method of white balance adjustment according to claim 1, further comprising counting the run-time of the LCD panel and writing a counting result into a first memory when the LCD panel is booted.

4. The method of white balance adjustment according to claim 3, wherein a timer is configured to count the run-time of the LCD panel.

5. The method of white balance adjustment according to claim 3, further comprising:
after each booting of the LCD panel, reading the first run-time of the LCD panel after the previous booting of the LCD panel from the first memory;
counting the run-time of the LCD panel after the present booting of the LCD panel to obtain the second run-time; and
obtaining the sum of the second run-time and the first run-time and writing the sum into the first memory to update the total run-time.

6. The method of white balance adjustment according to claim 1, wherein a second memory is configured to store the total run-time to white balance parameter table.

7. The method of white balance adjustment according to claim 1, further comprising:
looking up the total run-time to white balance parameter table according to the total run-time, and finding out the corresponding white balance parameter after each booting of the LCD panel.

8. A method of white balance adjustment, comprising following steps:
obtaining a total run-time of a liquid crystal display (LCD) panel;
finding out a corresponding white balance parameter according to the total run-time; and
compensating the LCD panel with the corresponding white balance parameter, so as to adjust the corresponding white balance parameter according to a run-time of the LCD panel.

9. The method according to claim 8, further comprising providing a first memory to store the total run-time.

10. The method according to claim 8, further comprising counting the run-time of the LCD panel and writing a counting result into a first memory when the LCD panel is booted.

11. The method according to claim 10, further comprising:
after each booting of the LCD panel, reading a first run-time of the LCD panel after a previous booting from the first memory;
counting the run-time of the LCD panel after a present booting to obtain a second run-time; and
obtaining a sum of the second run-time and the first run-time and writing into the first memory to update the total run-time.

12. The method according to claim 8, wherein the step of finding out the corresponding white balance parameter according to the total run-time further comprises:
pre-configuring a total run-time to white balance parameter table comprising multiple groups of run-time ranges and white balance parameter correspondence relationships; and
looking up the total run-time to white balance parameter table according to the total run-time, and finding out the corresponding white balance parameter after each booting of the LCD panel.

13. A liquid crystal display (LCD) for realizing white balance adjustment, comprising a white balance adjustment device, wherein the white balance adjustment device comprises:
an obtaining unit configured to obtain a total run-time of an LCD panel;
a matching unit configured to find out a corresponding white balance parameter according to the total run-time; and
a compensation unit configured to compensate the LCD panel with the corresponding white balance parameter, so as to adjust the corresponding white balance parameter according to a run-time of the LCD panel.

14. The liquid crystal display according to claim 13, wherein the white balance adjustment device further comprises a first memory configured to store the total run-time of the LCD panel.

15. The liquid crystal display according to claim 13, wherein the white balance adjustment device further comprises a timer configured to count the run-time of the LCD panel after each booting of the LCD panel.

16. The liquid crystal display according to claim 13, wherein the white balance adjustment device further comprises a timer, a first memory, and an update unit;
the timer is configured to count the run-time of the LCD panel after each booting of the LCD panel, and to write a counting result into the first memory; and
the update unit is configured to read a first run-time of the LCD panel after a previous booting of the LCD panel from the first memory, to obtain a sum of a second run-time of the LCD panel after a present booting of the LCD panel and the first run-time, and to write the sum into the first memory to update the total run-time.

17. The liquid crystal display according to claim 16, wherein the first memory comprises any one of programmable read-only memory, erasable programmable read-only memory, electrically erasable programmable read-only memory, and flash memory.

18. The liquid crystal display according to claim 14, wherein the white balance adjustment device further comprises:
a configuration unit configured to pre-configure a total run-time to white balance parameter table comprising multiple groups of run-time ranges and white balance parameter correspondence relationships;
wherein the matching unit is further configured to look up the total run-time to white balance parameter table according to the total run-time to find out the corresponding white balance parameter after each booting of the LCD panel.

19. The liquid crystal display according to claim 18, wherein the white balance adjustment device further comprises a second memory configured to store the total run-time to white balance parameter table.

20. The liquid crystal display according to claim 19, wherein the second memory comprises any one of programmable read-only memory, erasable programmable read-only memory, electrically erasable programmable read-only memory, and flash memory.
